(19) United States
(12) Patent Application Publication
(10) Pub. No.: US 2008/0087292 A1
(43) Pub. Date: Apr. 17, 2008

(54) DEVICE FOR ISOLATING AT LEAST ONE LOCK OF HAIR

(75) Inventors: Aline ABERGEL, BOULOGNE (FR); Charlotte GUERET, Paris (FR); Nicolas ALBISETTI, CLICHY (FR); Mathilde GATESOUPE, ASNIERES (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 11/871,470

(22) Filed: Oct. 12, 2007

Related U.S. Application Data
(60) Provisional application No. 60/853,003, filed on Oct. 20, 2006.

(30) Foreign Application Priority Data
Oct. 12, 2006 (FR) 0654224

(51) Int. Cl. A61Q 5/10; A45D 19/00; B65D 69/00

(52) U.S. Cl. 132/208; 132/270; 206/581

(57) ABSTRACT

A device and method isolate at least one lock of hair to which a product can be applied. An application set includes the device. A method of applying a product uses the application set. The device includes a base and first and second prongs extending from the base, the prongs including first and second longitudinal parts, respectively. The first and second longitudinal parts extend along respective first and second longitudinal axes, the first and second longitudinal parts defining between them an interior space configured to receive a lock of hair. The device further includes first and second projections extending from the first and second longitudinal parts, respectively, into the interior space. The first and second projections face one another. The first and second projection axes extend in first and second distinct planes. In other words, the first and second projection axes do not extend in a common plane.

### CROSS-REFERENCE TO RELATED APPLICATIONS

This document claims priority to French Application Number 06 54224, filed Oct. 12, 2006, and U.S. Provisional Application No. 60/853,003, filed Oct. 20, 2006, the entire content of each of which are hereby incorporated by reference.

### FIELD OF THE INVENTION

The present invention relates to a device for isolating at least one lock of hair to which a product can be applied. Examples of the product include cosmetic products, such as direct or indirect coloring products or color removal products. The expression “cosmetic product” is to be understood to mean a product as defined in Council Directive 93/35/EEC of 14 Jun. 1993.

### BACKGROUND OF THE INVENTION

### Discussion of Background

Favored, although non-exclusive, applications of the present invention involve applying color to and removing color from hair.

There are many devices that can be used to isolate locks of hair with a view to applying hair color to or removing color from isolated locks of hair. Documents DE 102 61 242, FR 2 589 337, FR 2 856 560, U.S. Pat. No. 5,231,999, U.S. Pat. No. 5,694,953 and document US Publication 2003/0188759 describe examples of devices that can be used to isolate selective locks of hair. Document FR 2 589 337 in particular describes a device comprising a base from which two hooks extend. These hooks are able to pick up a lock of hair. However, one disadvantage associated with such a device is that when the device is moved from the root of the lock to the end, there is a significant risk of pulling hair out. Document FR 2 856 560 describes another example of a device including a comb with a row of teeth. Of this row of teeth, two teeth together internally define a space intended to receive a lock of hair. One of the teeth has a relief projecting into this space. This space is therefore accessible through a passage extending between the relief and the tooth. One disadvantage associated with such a device is that it is difficult to hold the lock of hair correctly between the teeth of the comb. This is because when this comb is being used, some of the hair that makes up the lock can easily escape from the space defined between the tooth and the relief.

### SUMMARY OF THE INVENTION

One aspect of the present invention provides a device and a method for isolating locks of hair which overcome at least one of the aforementioned disadvantages.

One aspect of the invention provides a device configured to isolate at least one lock of hair to which a product can be applied. In this example, the device includes a base and first and second prongs extending from the base. The prongs typically include first and second longitudinal parts, respectively. In other words, each prong has one longitudinal part. The first and second longitudinal parts extend along respective first and second longitudinal axes. The first and second longitudinal parts define between them an interior space configured to receive a lock of hair. The first and second projections extend from the first and second longitudinal parts, respectively, into the interior space. The first and second projections face one another. The first and second projection axes extend in first and second distinct planes. In other words, the first and second projection axes do not extend in a common plane.

Another aspect of the invention provides a packaging and application set for packaging a product and applying it to a lock of hair. The packaging and application set typically includes an embodiment of the device described above. The packaging and application set further includes a container positioned in fluidic communication with the base of the device.

Another aspect of the present invention provides a device and a method for isolating locks of hair which facilitate the isolating of locks of hair and keep hold of the locks of hair effectively, particularly when the device is moved along the lock of hair.

Yet another aspect of the present invention is to provide a device that is simple to manufacture and to use, and has a low price.

One example of the present invention provides a device for isolating at least one lock of hair to which a product can be applied, this example of the device includes a base, at least two prongs extending from the base, each prong comprises a longitudinal part extending along a respective longitudinal axis. The longitudinal parts define between them an interior space intended to receive a lock of hair. A projection extends from the longitudinal part into the interior space. The projections face one another and extend in two distinct planes.

The planes may be parallel or secant.

The longitudinal axes of the longitudinal parts may be parallel or secant.

The projections may each include a longitudinal face. These longitudinal faces can be flat and can extend along a respective plane. These planes of the adjacent longitudinal faces may be secant and together make an angle of less than 120°. An arrangement such as this allows the projections to form an inlet cone able to guide the lock of hair as it becomes inserted in the device.

Each projection may extend obliquely relative to its longitudinal part. A feature such as this, combined with the arrangement whereby the projections face one another, makes it possible to orientate the way in which the lock of hair is positioned in the interior space.

Each projection may have an axis of elongation which makes an acute angle with the axis of its respective longitudinal part. This angle is, for example, typically smaller than 80°. An angle such as this allows the hair to be held correctly between the longitudinal part and the free end of the projection. Furthermore, the axes of elongation of the projections may be secant in the interior space.

Each longitudinal part may be connected to its projection by a rounded external edge. As the lock is positioned in the interior space, the device is positioned facing the scalp. The device may therefore knock against the scalp and the rounded external edge then prevents the device from pricking the scalp.

Each longitudinal part may also be connected to its projection by a rounded internal edge. This rounded internal edge for its part prevents the hair from becoming caught between the longitudinal part and the projection and thus avoids any risk of hair being stretched or even broken as the device is moved relative to the lock of hair held.

The projections may extend on each side of a plane of symmetry running perpendicular to a first face of the base. Such symmetry allows the user easily to orientate the device in order to apply product and obviates the need for an indexing means.

The projections may together define a slot. A slot such as this allows the lock of hair to be inserted easily into the interior space.

The prongs may be elastically deformable. Such flexibility allows the prongs, and particularly their projections, to part so as to house the lock of hair in the interior space. The lock of hair may possibly be received gripped tightly between the prongs.

The base may internally include a passage, preferably open at both ends. In other words, the passage preferably passes through the base from one side to another.

The passage may have an opening which opens into the interior space. This end may thus allow a product flowing along the passage to be distributed directly to the lock of hair positioned between the prongs.

Another exemplary aspect of the present invention is to provide a set for packaging a product and applying it to a lock of hair, including a device as discussed hereinabove and a container positioned in fluidic communication with the base of the device.

The container may be provided with a dispensing wand extending along a longitudinal axis, it being possible for the opening of the passage to extend along the longitudinal axis of the wand. The set may further comprise a flexible sleeve at least partially enveloping the dispensing wand. The sleeve may comprise an end portion provided with an elastomeric band in which a slot is formed. Another aspect of the present invention is to provide a method of applying a product to a lock of hair. One example of the method includes the steps of providing a set according to the invention, placing a lock of hair between the at least two prongs, dispensing the product through the base in such a way as to apply the product to the lock of hair.

As should be apparent, the various examples of the invention discussed above and below can provide a number of advantageous features and benefits. It is to be understood that, in practicing the invention, an embodiment can be constructed to include one or more features or benefits of embodiments, disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A better understanding of the various aspects of the invention will be gained from reading the following description in conjunction with the accompanying figures. The figures are offered purely as a guide and by way of example, and in no way limit the invention.

FIG. 1 is a schematic perspective view, slightly from the side, of one embodiment of a device according to the invention;

FIG. 2 is a schematic perspective view from the front of the device of FIG. 1;

FIG. 3 is a schematic view from above of the device of FIG. 1;

FIG. 4 is a schematic view from above of an alternative embodiment of a device according to one aspect of the invention;

FIG. 5 is a schematic view from above of another alternative embodiment of a device according to one aspect of the invention;

FIG. 6 is a schematic perspective view of a packaging and application set according to one aspect of the invention;

FIGS. 7-10 depict four successive steps in an example of a method using the packaging and application set according to one aspect of the invention of FIG. 6;

FIG. 11 depicts an alternative embodiment of a packaging and application set according to one aspect of the invention; and

FIGS. 12-15 depict four successive steps in another example of a method employing the packaging and application set according to one aspect of the invention of FIG. 11.

### DETAILED DESCRIPTION OF THE PREFERRED EMBODIMENTS

Referring now to the drawings in which like reference numerals are used to designate identical or corresponding parts throughout the several views.

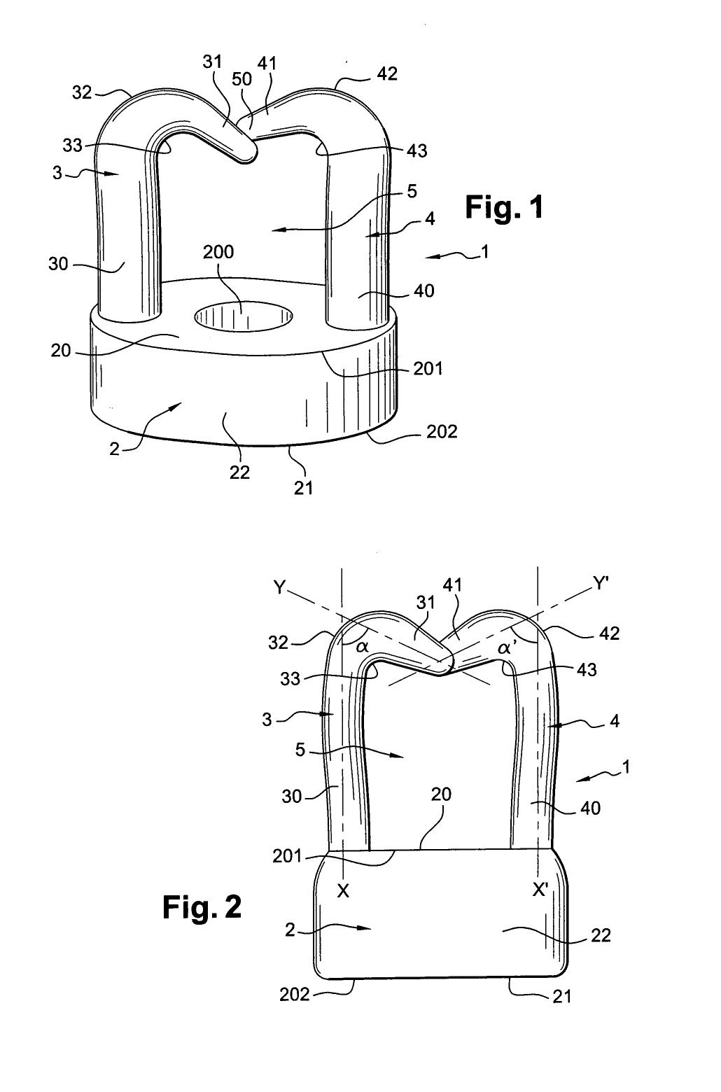

FIGS. 1 to 5 depict various embodiments of a device 1 according to the present invention, intended to isolate at least one lock of hair. These figures show this device in the rest position. In this position, the device is preferably not under any external stress.

With reference to FIG. 1, the depicted example of the device comprises a base 2 and at least two prongs 3 and 4.

The base 2 may have any appropriate configuration, such as an overall configuration in the shape of a cylinder, an ellipsoid, a parallelepiped or the like. In this example, the base 2 is an ellipsoid having a first face 20 and an opposite second face 21. The two faces are connected to one another by a side wall 22. The two faces are parallel, and each defines an elliptical periphery 201 and 202. These peripheries 201 and 202 are preferably perfectly identical so that they can be superposed on one another.

The first face 20 is preferably provided with an opening 200, the function of which is explained below. The second face 21 may also be provided with an opening (not visible) the function of which is also explained below. Preferably, a passage passing through the base 2 connects these two openings.

In the exemplary embodiment depicted, first and second prongs 3 and 4 have an overall shape of a hook or fish hook. The first and second prongs 3 and 4 are advantageously at least partially flexible and preferably elastically deformable. The first and second prongs 3 and 4 may, for example, be made of polyamide, polypropylene, polyethylene, polyoxymethylene. Although only two prongs are shown, more may be included.

The prongs 3 and 4 extend from the base 2. Such prongs include first and second respective longitudinal parts 30 and 40 rising up from the base and respective projections 31 and 41 standing out from the longitudinal parts. These first and second longitudinal parts 30 and 40 are advantageously joined to the respective first and second projections 31 and 34 by an external edge 32, 42 and an internal edge 33, 43. Preferably, these external 32, 42 and internal 33, 43 edges have a curved or rounded configuration to reduce the risk of damage to the hair.

The first and second longitudinal parts 30 and 40 extend from the base 2. These longitudinal parts therefore each have a first end secured to the base 2 and an opposite second end. The second end is free of the base 2 and preferably connected only to the associated projection 31 or 41. In particular, the longitudinal parts extend in the continuation of the side wall 22 of the base.

The first and second longitudinal parts 30 and 40 extend along respective first and second longitudinal axes X and X′. The first and second axes X and X′ may, as depicted in FIG. 2, be substantially parallel. However, the first and second axes X and X′ may instead be secant. In the latter instance, the longitudinal parts may extend in such a way that they diverge from one another in order to accept hair more easily or alternatively that they converge towards one another to better hold hair. With respect to the first face 20 of the base 2, the first and second axes X and X′ may thus cross one another over this first face 20 when the longitudinal parts diverge from one another, or under this first face 20 when the longitudinal parts are directed towards one another.

The first and second longitudinal parts 30 and 40 between them define an interior space 5 configured to house a lock of hair as will be seen later on.

The first and second projections 31 and 41 extend from their respective first and second longitudinal parts 30 and 40, projecting into the interior space 5. The first and second projections 31 and 41 may be directed towards one another. Each projection preferably forms a prong portion that projects into the interior space. Thus, the first and second projections 31 and 41 each preferably have a respective free end located inside the interior space. Preferably, these projections stand out from the second ends of the longitudinal parts. The first and second projections 31 and 41 may extend at any height along the first and second longitudinal parts 30 and 40. These projections preferably face one another and may be separated from one another by a slot 50 for the insertion of a lock of hair into the interior space 5. Such projections may thus form means for retaining the locks inserted inside the interior space.

The first and second projections 31 and 41 extend along first and second axes of elongation Y and Y′, respectively. Such projections may extend obliquely or orthogonally to the longitudinal parts 30 and 40. The first and second axes of elongation Y and Y′ of the projections and the first and second longitudinal axes X and X′ of the longitudinal parts may together make first and second angle α and α′, respectively. The angles α and α′ may be identical to or different from one another. According to one advantageous embodiment, these angles are acute angles. For example, these angles may be smaller than 80° in order to facilitate holding of the hair. The first and second axes of elongation Y and Y′ may be secant inside the interior space 5.

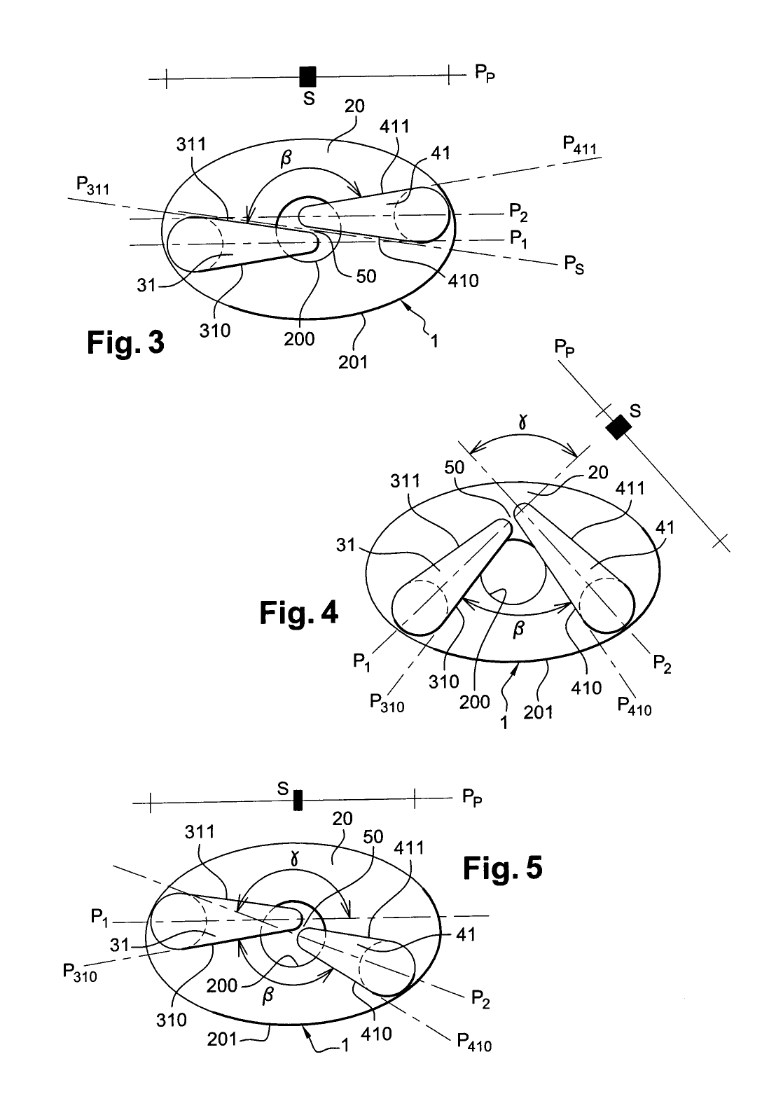

In this exemplary embodiment, the first and second projections 31 and 41 have a substantially conical overall shape comprising a pointed free end, but non-conical arrangements are possible. As can be seen in FIG. 3, the projections 31 and 41 each include a first longitudinal face 310, 410, respectively and a second longitudinal face 311, 411, respectively.

According to one example of the invention, the first and second axes Y and Y′ of the first and second projections 31 and 41 extend along two different planes P1 and P2 respectively.

As depicted in FIG. 3, these two planes P1 and P2 may be parallel. The projections 31 and 41 then extend in a row, offset from one another.

In another embodiment, as can be seen in FIGS. 4 and 5, the two planes P1 and P2 may be secant. Preferably, the two planes P1 and P2 intersect at the level of the first face 20 of the base 2. The two planes may, for example, together make an angle γ advantageously ranging between 100 and 180°.

In FIG. 4, the free end of the first projection 31 faces the first longitudinal face 410. The planes P1 and P2 together make an angle γ of about 100°. In this exemplary embodiment, the planes intersect near the elliptical periphery of the first face 20 of the base.

In FIG. 5, the free end of the second projection 41 faces the first longitudinal face 310. The first and second planes P1 and P2 together make an angle γ of about 150°. In this exemplary embodiment, the planes P1 and P2 intersect substantially at the center of the first face 20 of the base 2.

The slot 50 may be defined between two adjacent longitudinal faces of the first and second projections 31 and 41, namely between the first longitudinal faces 310 and 410 or between the second longitudinal faces 311 and 411 as depicted in FIG. 3. As an alternative, this slot may be defined between the free end of one projection and the first or second longitudinal face of the projection facing it, as depicted in FIGS. 4 and 5. In yet another alternative, this slot may be defined between the free ends of the projections.

The adjacent longitudinal faces 310, 410; 311, 411 extend in respective planes P311, P411; P310, P410. These planes may be secant. The planes 310, 410 then together make an angle β preferably smaller than the angle γ and for example smaller than 120°. The first longitudinal faces 310, 410 or the second longitudinal faces 311, 411 then converge towards one another. An arrangement such as this, preferably combined with the fact that the axes of elongation Y and Y′ of the projections make an acute angle with the longitudinal axes X and X′ of the respective longitudinal parts, makes it possible to form an inlet cone for the lock of hair between the projections. This inlet cone gradually narrows towards the slot 50 and makes it easier for the lock to access the interior space 5. As a result, this arrangement guides the lock of hair as it is being inserted into the device.

According to one embodiment, the projections may extend on each side of a plane of symmetry Pₛ running perpendicular to the first face 20 of the base. A configuration such as this allows the user easily to identify what orientation the device has before use.

According to one advantageous feature depicted in FIGS. 3, 4, and 5, the first and second projections 31 and 41, when projected orthogonally to the plane P1 or P2 onto a plane of projection Pp, may be superposed on one another, at least in part. In FIGS. 3 and 5, when the projections 31 and 41 are projected orthogonally to the plane P1, they become superposed on a plane of projection P parallel to P1 on a surface S of the plane of projection. In FIG. 4, when the projections 31 and 41 are projected orthogonally to the plane P2 onto a plane of projection Pp parallel to P2, these projections become superposed on a surface S of the plane of projection.

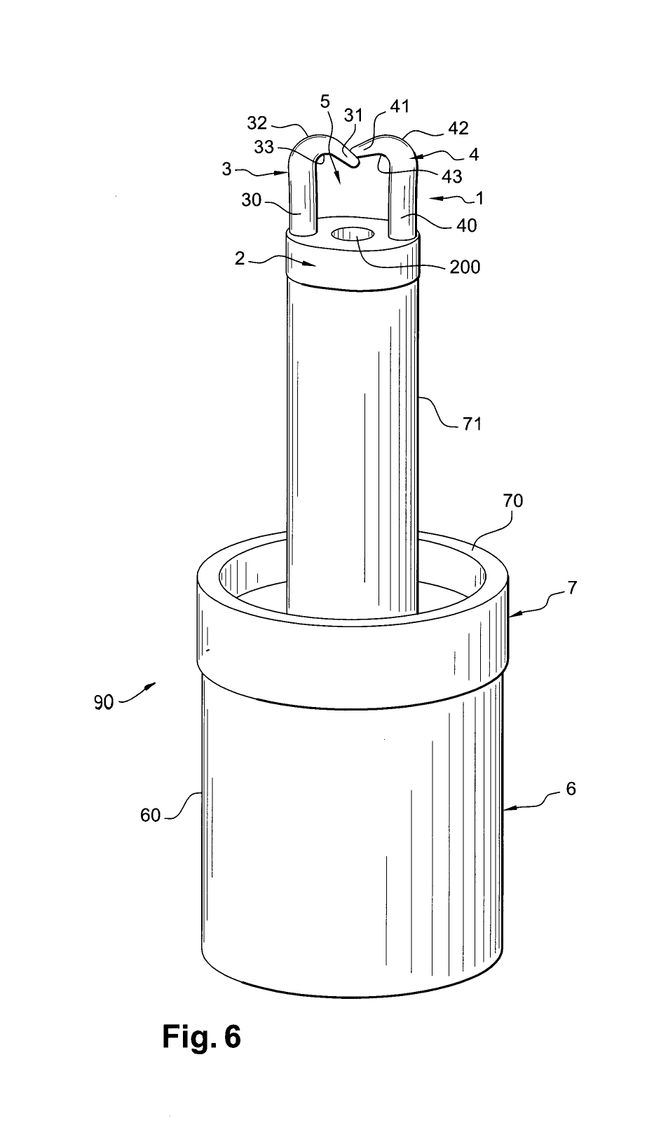

FIG. 6 depicts an example a packaging and application set 90 according to one embodiment of the present invention. This set comprises a device 1 according to the discussion above, associated with a container 6. This device is preferably connected to the container by connecting means 7, which can be, for example, a snap-on top or a threaded coupling.

The container 6 internally defines a reservoir for the product. This container comprises an open end through which the product can be dispensed. The product may be a hair treatment product of the hair color or color remover type.

This container may be made of any appropriate materials and may have various configurations, and the way in which this container is embodied not in any way restricting the present invention. For example, the container may be of cylindrical shape. This container comprises side walls 60 which are preferably deformable. The product can then be dispensed as a result of pressure exerted on these walls.

The connecting means 7 comprise an attachment ring 70 and a dispensing wand 71. In this exemplary embodiment, the dispensing wand 71 extends vertically from the attachment ring 70. The ring 70 and the wand 71 may be produced as one, i.e., as an integral component.

The ring 70 may be attached to the container 6 by any appropriate means. The ring 70 may, for example, be a ring to be screwed, crimped, clipped or force-fitted onto the open end of the container. As shown in FIG. 6, the ring 70 may include an annular cavity relative to the wand 70. One benefit of this arrangement is that fluid exiting the wand 71 can be captured without dripping down the side walls 60.

In the illustrated example, the dispensing wand 71 comprises an anchoring portion for the base 2 of the device. This wand 71 extends along a longitudinal axis and internally defines a duct which communicates with the passage of the base 2. Thus, product leaving the container 1 can pass through the duct in the wand 71 and the passage in the base 2 before being dispensed through the opening 200. The opening 200 extends along the longitudinal axis of the wand 71. An outlet valve (not visible) may be provided in this duct or this passage to ensure selective dispensing of the product contained in the container. Alternatively, the opening 200 may be produced in the form of a self-sealing lip.

The device 1 may, as depicted, be a part attached to the connecting means 7. In this case, the base 2 then forms an end-piece to be fixed onto the connecting means. As depicted in FIG. 6, the base 2 may be fixed to the dispensing wand 71. The fixing may be done using any appropriate means. Additionally, it is possible for the device 1 and the connecting means 7 or alternatively for the device 1, the connecting means 7, and the container 6, to be produced as one entity.

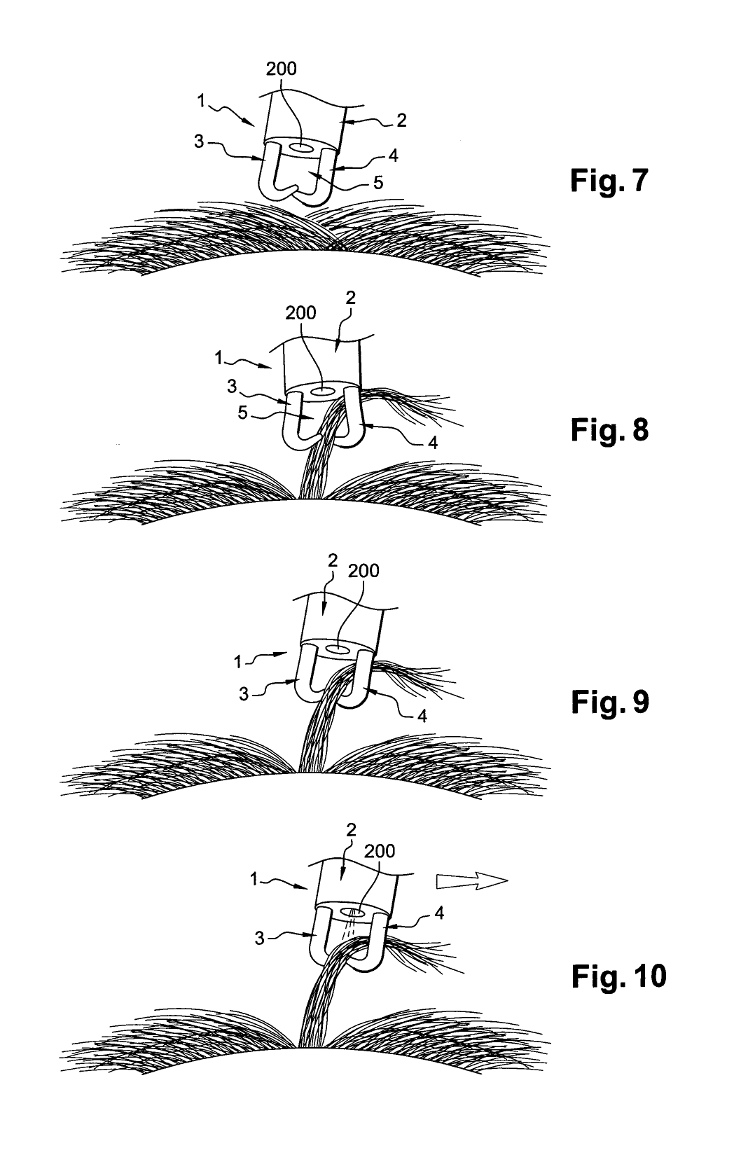

An example of a way in which the illustrated device works will now be described with reference to FIGS. 7-10, which depict an advantageous way of using the application and packaging set according to one example of the present invention.

In a first step illustrated in FIG. 7, the prongs 3 and 4, are positioned facing the scalp. If the device comes into contact with the scalp, the rounded external edges 32 and 42 prevent the user from injuring herself. Accordingly, it is advantageous to dispose the first and second projections 31 and 41 on an outermost point on the longitudinal parts 30 and 40 to prevent part of the first and second longitudinal parts from gouging the user's scalp. Additionally, the first and second projections 31 and 41 can be the sole projections disposed on the first and second longitudinal parts, respectively.

In a second exemplary step illustrated in FIG. 8, the prongs 3 and 4 take hold of a lock of hair.

In a first exemplary method of use, the projections 31 and 41 can part in order to receive the lock of hair into the interior space 5. This parting is a result of the flexible nature of the prongs. In this case, the user may take the lock of hair in her hand then bring the projections into contact with the lock. The act of pushing the projections against the lock may then force the projections apart.

According to a second exemplary method of use, the lock of hair may be placed in the interior space 5 without the need for the user to take hold of the lock of hair beforehand. To do this, the user collects a lock through the slot 50 by pushing the device into her head of hair. The user may possibly make arc-shaped movements in order to encourage the lock of hair to enter the slot 50.

According to a third exemplary method of use, and with reference to FIG. 3, the lock of hair can be introduced between the faces 311 and 410. The lock is then inserted into the interior space 5 running parallel to the plane of symmetry Ps, and in particular, coinciding with this plane of symmetry. Thereafter, once the lock has moved past the hooks, the device can be turned in such a way that the lock is held correctly in the interior space. This twisting preferably causes the lock to be positioned 90° or more from the plane P1. The overlapping free ends of the projections then prevent the lock from escaping from the interior space 5.

In a third exemplary step illustrated in FIG. 9, the lock is held in the interior space 5. Because the prongs are elastically deformable, the device 1 has shape memory and the first and second projections 31 and 41 return to their initial configuration. Once the lock has been inserted, the fact that the first and second projections 31 and 41 do not extend in the same plane increases the area over which the lock bears against the projections 31 and 41 and thus better stabilizes the lock in the device 1. In particular, the acute angle formed between the projections and their respective longitudinal parts allows the lock of hair to be confined correctly in the interior space 5 on the rounded internal edges 33 and 43.

In a fourth exemplary step illustrated in FIG. 10, the packaging and application set is moved longitudinally relative to the lock of hair. At the same time as the set 90 is moved, the user causes product to be dispensed. The product is therefore expelled through the opening 200 and comes into contact with the lock of hair. The rounded internal edges 33 and 43 therefore prevent hair from becoming caught between the projections 31 and 41 and their respective longitudinal parts 30 and 40.

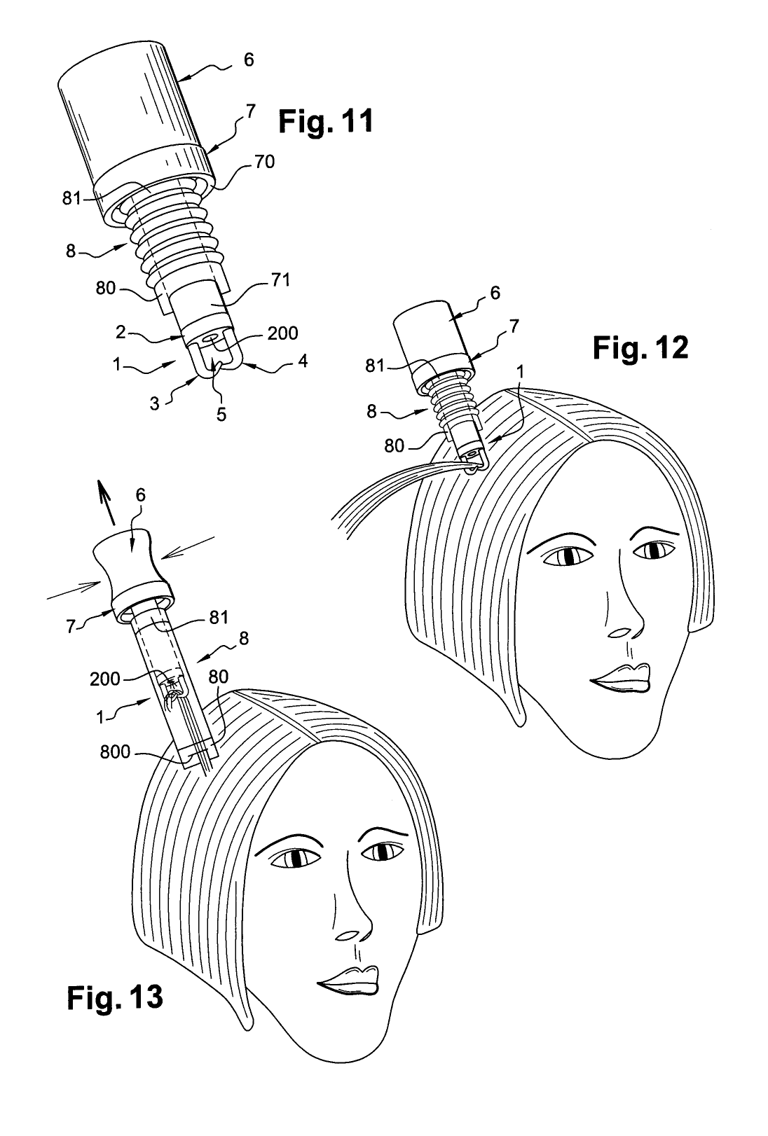

FIGS. 11 to 15 show a second advantageous method of using a packaging and application set 8 according to one example of the present invention. In this case, the packaging and application set 90 may be provided with a sleeve 8, preferably a flexible sleeve. This sleeve 8 may, for example, be made of polyethylene.

A sleeve 8 such as this may have a tubular shape and have two end portions 80 and 81 each having an open free end. Each opening may be closed off by closure device. The closure device may, for example, comprise a hook and loop VELCRO® (hook and loop) system or a crushable metal ring. In an advantageous alternative embodiment, the free end of the end portion 80 may be closed off in particular by sealing, and an elastomeric band may be secured to the sleeve 8. This elastomeric band is advantageously provided near the end portion 80. An opening in the form of a slot 800 may then be formed through this elastomeric band. The elastomeric band may, for example, be made of a thermoplastic elastomer (TPE), a thermoplastic urethane (TPU), of silicone, of natural rubber or synthetic rubber or of polyurethane.

The openings in the sleeve 8 preferably allow the sleeve 8 to be slipped onto the dispensing wand 71. As depicted in FIG. 11, this sleeve may be mounted on the dispensing wand 71 in such a way that it at least partially, and preferably fully, envelopes this wand.

In a first step illustrated in FIG. 12, the lock of hair is first of all taken between the prongs 3 and 4 of the device 1, generally near the scalp.

In a second exemplary step illustrated in FIG. 13, the sleeve 8 may be fixed to the lock of hair. To do this, the end portion 80 may be closed off by joining the VELCRO® (hook and loop) bands together or by crushing the metal ring on either side of the lock. When the end portion 80 comprises an elastomeric band, the lock of hair is passed through the slot 800. The elastomeric properties of the elastomeric band allow the latter to close tightly around the lock of hair. An elastomeric band such as this thus anchors the sleeve 8 firmly on the lock.

The user may then deploy the sleeve over the lock of hair by moving the packaging and application set 90 along the lock. During this deployment, the user can hold the end portion 80 of the sleeve to keep this portion firmly in place on the lock.

Deploying the sleeve 8 allows a particular lock of hair to be isolated. The product contained in the container 6 can then be dispensed onto this lock specifically. This dispensing of product is advantageously done at the same time as the packaging and application set 90 is moved relative to the lock. It should be noted that providing the longitudinal parts 30 and 40 of the prongs and the opening 200 along the longitudinal axis of the dispensing wand 71 is a particularly advantageous arrangement because it prevents them from impeding the positioning of the sleeve 8 on the dispensing wand 71 and from impeding its deployment around the lock of hair that is to be isolated.

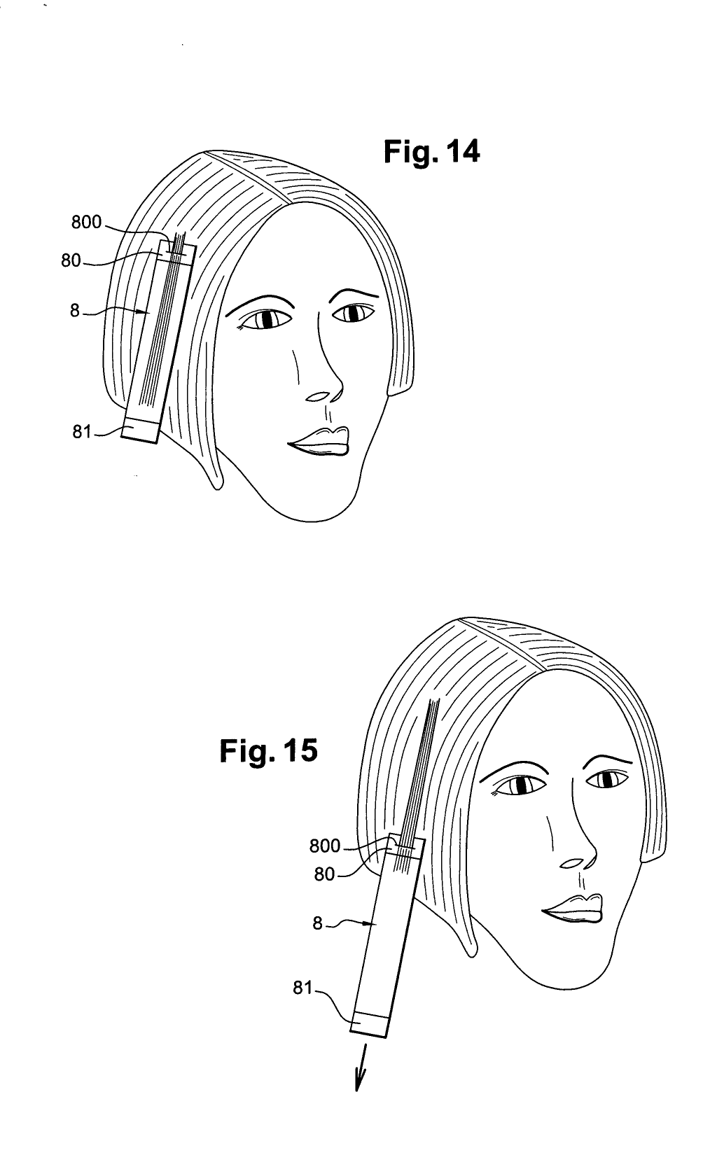

In an exemplary third step illustrated in FIG. 14, the sleeve 8 can then be completely detached from the packaging and application set 90. The end portion 81 may be closed off in order to confine the lock and the dispensed product inside the sleeve 8. This closing-off of the end portion 81 is preferably done beyond the end of the lock of hair. The product can then remain in contact with the lock for the required length of time without the risk of applying color to adjacent locks. It is also possible for the sleeve 8 to be kneaded in order to ensure close contact between the product and the confined lock.

In a fourth exemplary step illustrated in FIG. 15, once the user believes that the product has been in contact with the lock for long enough, the user can extract the lock from the sleeve 8. This extraction can be done by pulling the sleeve 8 relative to the lock while at the same time keeping the end portion 80 in close contact around the lock. Pulling in this way then allows the lock to be rid of any surplus product there might be. In other words, the sleeve 8 wipes off excess product from the lock.

Throughout the description and claims, expressions such as “comprising a,” “having one,” “including one,” and “has one” should be considered to be synonymous with “comprising at least one,” unless specified otherwise.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent fo the United States is:

1. A device for isolating at least one lock of hair to which a product can be applied, the device comprising:
a base,
first and second prongs extending from the base, the prongs including first and second longitudinal parts, respectively,
the first and second longitudinal parts extending along respective first and second longitudinal axes, the first and second longitudinal parts defining between them an interior space configured to receive a lock of hair,
first and second projections extending from the first and second longitudinal parts, respectively, into the interior space, the first and second projections facing one another,
wherein the first and second projection axes extend in first and second distinct planes such that the first and second projection axes do not extend in a common plane.

2. The device according to claim 1, wherein the first and second distinct planes are parallel.

3. The device according to claim 1, wherein the first and second distinct planes are secant.

4. The device according to claim 1, wherein the first and second longitudinal axes of the first and second longitudinal parts are parallel.

5. The device according to claim 1, wherein the first and second longitudinal axes of the first and second longitudinal parts are secant.

6. The device according to claim 1, wherein each of the first and second projections comprises a longitudinal face, said longitudinal faces being adjacent and extending in a respective plane, the respective planes being secant and together making an angle of less than 120°.

7. The device according to claim 1, wherein the first projection axis extends at an oblique angle relative to the first longitudinal axis, and the second projection axis extends at an oblique angle relative to the second longitudinal axis.

8. The device according to claim 1, wherein the first projection axis is disposed at a first angle relative to the first longitudinal axis, and the second projection axis is disposed at a second angle relative to the second longitudinal axis, and the first and second angles are both less than 80°.

9. The device according to claim 1, wherein each longitudinal part is connected to its projection by a rounded external edge disposed on a side of the projection facing the base.

10. The device according to claim 1, wherein the first and second longitudinal parts are each connected, respectively, to the first and second projections by a rounded internal edge disposed on a side of the projection opposite the base.

11. The device according to claim 1, wherein the one of the first and second projections extends on each side of a plane of symmetry that runs perpendicular to a first face of the base.

12. The device according to claim 1, wherein the first and second projections together define a slot disposed between the first and second projections.

13. The device according to claim 1, wherein the first and second prongs are elastically deformable.

14. The device according to claim 1, wherein the base internally defines a passage.

15. The device according to claim 14, wherein the passage is open at two ends such that the passage passes through the base from one side of the base to another.

16. The device according to claim 1, wherein the passage includes an opening which opens into the interior space.

17. The device according to claim 1, wherein, when the first and second projections are projected in a direction orthogonal to one of the first and second distinct planes onto a plane of projection, which is parallel to the one of the first and second distinct planes, the projections overlap.

18. A packaging and application set for packaging a product and applying the product to a lock of hair, comprising:
a device according to claim 1,
a container positioned in fluidic communication with the base of the device.

19. The packaging and application set according to claim 18, wherein the container includes a dispensing wand extending along a wand longitudinal axis, and the base of the device includes an opening extending along the longitudinal axis of the dispensing wand.

20. The packaging and application set according to claim 19, further comprising a flexible sleeve at least partially enveloping the dispensing wand.

21. The packaging and application set according to claim 20, wherein the sleeve comprises an end portion provided with an elastomeric band including a slot

22. The packaging and application set according to claim 19, further comprising a ring surrounding the dispensing wand and configured to hold the dispensing wand in fluid communication with the container.

23. The packaging and application set according to claim 22, wherein the ring provides a cavity around the dispensing wand.

24. A method of applying a product to a lock of hair, comprising the steps of:
providing a base with first and second prongs extending from the base, the prongs including first and second longitudinal parts, respectively, the first and second longitudinal parts extending along respective first and second longitudinal axes, the first and second longitudinal parts defining between them an interior space configured to receive a lock of hair,
providing first and second projections extending from the first and second longitudinal parts, respectively, into the interior space, the first and second projections facing one another, wherein the first and second projection axes extend in first and second distinct planes; and
providing a container positioned in fluidic communication with the base of the device;
placing a lock of hair between the first and second prongs; and
dispensing the product through the base in such a way as to apply the product to the lock of hair.
